(19) United States
(12) Patent Application Publication
(10) Pub. No.: US 2011/0095496 A1
(43) Pub. Date: Apr. 28, 2011

(54) WHEELABLE PUSH/PULL HANDLE LAUNDRY BASKET

(76) Inventor: Alivia Kassab Arabo, West Bloomfield, MI (US)

(21) Appl. No.: 12/906,205

(22) Filed: Oct. 18, 2010

Related U.S. Application Data
(60) Provisional application No. 61/254,073, filed on Oct. 22, 2009.

(51) Int. Cl. B62B 3/02; B62B 3/14

(52) U.S. Cl. 280/33.992; 280/47.26

(57) ABSTRACT

A wheeled basket having a body and a wheeled support incorporated into a bottom proximate extending edge of said body. Either of an extensible or pivotal handle is secured to a rear or inside rear portion of the body. A rear extending pad support can be secured to the body and is adapted to establish a sliding surface for vertically traversing said along edge surfaces associated with each succeeding stair riser interface. A strap is secured over an open top of the body. Additional variants can include a redesigned body including a main frame, an upper pivotal support secured to a first location of the main frame, with a second lower pivotal support secured to a second location.

### CROSS-REFERENCE TO RELATED APPLICATIONS

This Application claims the benefit of U.S. Provisional Application 61/254,073 filed on Oct. 22, 2009.

### FIELD OF THE INVENTION

The present invention relates generally to a wheeled and stackable basket assembly. More specifically, the present invention discloses a modified basket/hamper design and which includes an extensible handle assembly connected to a wheeled hamper body. Additional features include a projecting rear support surface associated with the interface of the handle with the hamper body, and which operates to provide a sliding surface for vertically traversing the hamper along edge surfaces associated with each succeeding stair riser interface.

### BRIEF DESCRIPTION OF THE PRIOR ART

The prior art is documented with various types of wheeled hampers or baskets. Typical examples of these include such as the wheeled hamper with pivotal handle as set forth in Craft, U.S. Pat. No. 6,036,204, the wheeled hamper of U.S. Pat. No. 5,511,807 to Snyder, the wheeled hamper with telescoping handle set forth in U.S. Publication No. 2007/0187912 to Taulman, the laundry basket on wheels disclosed in Ronson, U.S. Design No. 440,020, and the laundry cart of Rivera, U.S. Design No. 486,619. Additional and like known commercial designs include the shopping baskets disclosed in Xian yuanfar international and Highbright Enterprise Limited.

### SUMMARY OF THE INVENTION

The present invention discloses an improved wheeled basket, such as which is useful for traversing across vertical stair risers. The term basket is intended to encompass any rigid type body exhibiting a volume supporting interior and includes a wheeled support incorporated into a bottom proximate extending edge of said body. Additional to rigid baskets, other variants disclosed teach mesh type enclosures which can be suspended from supporting locations of a redesigned body.

Either of an extensible or pivotal handle is secured to a rear or inside rear portion of the body. A rear extending pad support can be secured to the body and operates to provide a sliding surface for vertically traversing the hamper along edge surfaces associated with each succeeding stair riser interface.

Additional features include the provision of a strap secured over an open top of the body. A further variant of the body can exhibit a generally planar and pane-like composition and which further includes a main frame, an upper pivotal support secured to a first location of the frame, and a second lower pivotal support secured to a second location. The upper and lower pivotal supports operates to define corresponding upper and lower supports for receiving a volume defining mesh or like enclosure for holding clothing or other objects.

### BRIEF DESCRIPTION OF THE DRAWINGS

Reference will now be made to the attached drawings, when read in combination with the following detailed description, wherein like reference numeral refer to like parts throughout the several views, and in which:

FIG. 1 is a perspective view of a wheeled basket assembly according to a first variant;

FIG. 2 is a rotated and rear facing perspective view of the variant of FIG. 1;

FIG. 3 is an exploded view of the variant of FIG. 1;

FIG. 4 is an assembled perspective similar to FIGS. 1 and 2 and illustrating the handle subassembly in a fully retracted position;

FIG. 5 is a side rear cutaway, taken along line 5-5 of FIG. 1, illustrating the configuration of the extensible handle in a fully extended position;

FIG. 6 is a succeeding illustration, taken along line 6-6 of FIG. 4, of the handle in a fully retracted position.

FIG. 7 is a further rotated and assembled perspective of a modified variant illustrating an alternately configured handle in a generally upwardly extended position;

FIG. 8 is a further rotated perspective and showing the design of FIG. 7 with the handle inwardly rotated to an inner stored position relative to an open interior of the basket;

FIG. 9 is an exploded view of the variant of FIG. 7;

FIG. 10 is a side cutaway view taken along line 10-10 of FIG. 7 and illustrating the configuration of the rotating handle in an upwardly extended position;

FIG. 11 is a succeeding illustration taken along line 11-11 of FIG. 8 of the handle in the inwardly rotated stored position;

FIG. 12 is a perspective illustration of a wheeled assembly according to a yet further variant and exhibiting an integrally formed handle;

FIG. 13 is a rotated perspective of the assembly shown in FIG. 12;

FIG. 14 is an exploded view of the assembly of FIG. 12;

FIG. 15 is an assembled and environmental perspective of a basket design according to a still further variant and showing a wheel supported frame to which are pivotally secured upper and lower support portions;

FIG. 16 is an exploded view of the variant of FIG. 15;

FIG. 17 is an illustration of the design in FIG. 15 in a fully folded-up and stored position;

FIG. 18 is an illustration of a yet further variant of basket design and illustrating an overhead extending support strap in combination with a rear secured and extensible handle and optional pad support surface defined on a hidden rear surface for facilitating traverse of vertical stair risers; and

FIG. 19 is a redesigned variant of wheelable basket similar to that shown in FIG. 18 and further illustrating the feature of an additional pivotal handle secured proximate opposite and upper edge locations of the basket and which is rotatable over the support strap also depicted in FIG. 18.

### DETAILED DESCRIPTION OF THE PREFERRED EMBODIMENTS

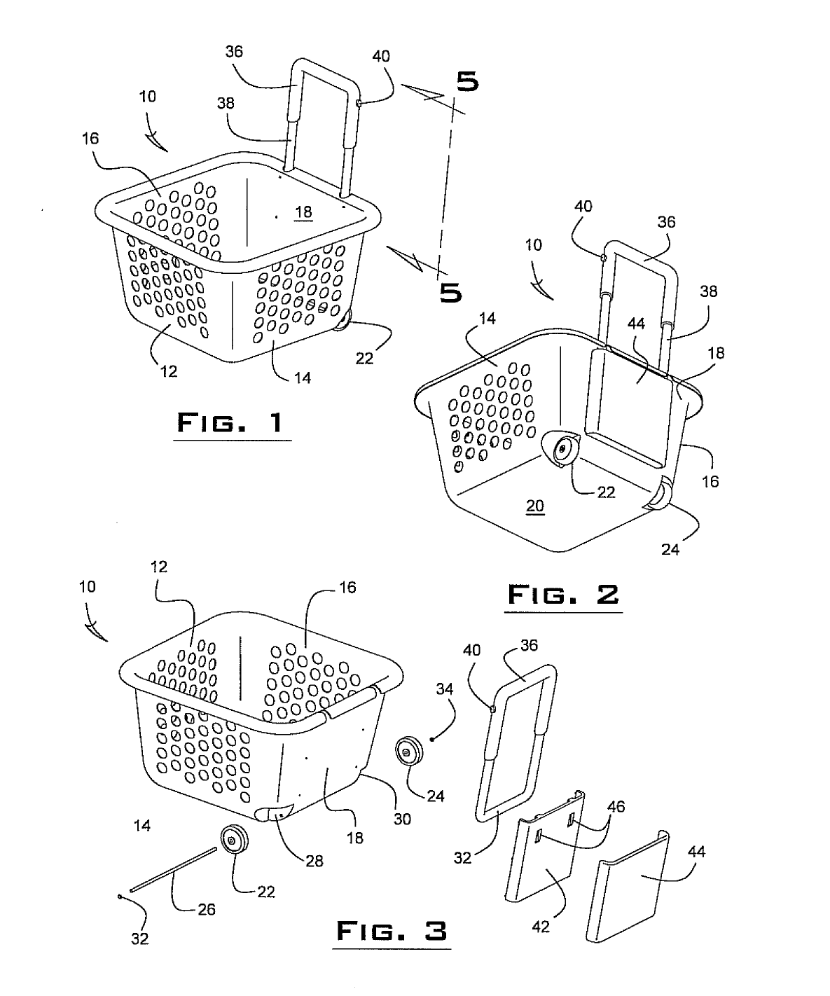

Referring to FIGS. 1-6, a series of perspective, exploded and cutaway views are illustrated of a wheel-able and push/pull basket assembly, generally shown in assembled fashion at 10 in FIGS. 1, 2 and 4, according to a first non-limiting variant. As described previously, the present invention seeks to provide a wheeled basket with a unique body construction including bottom edge wheeled support (either or both forward or wheel axle supported) in combination with a version of retractable handle in combination with a rear body surface defined pad or like supporting surface for providing ease of transport along level surfaces, as well as up and down stairs in controlled and substantially frictionless contacting fashion between edge adjoining portions of succeeding stair risers.

The basket construction is further such that it provides ease of stack-ability. Additionally, and as will be described throughout the following embodiments, the basket provides additional features which can include biasing or cushioning rear supports for assisting in successive displacement over riser edges of stairs and the like.

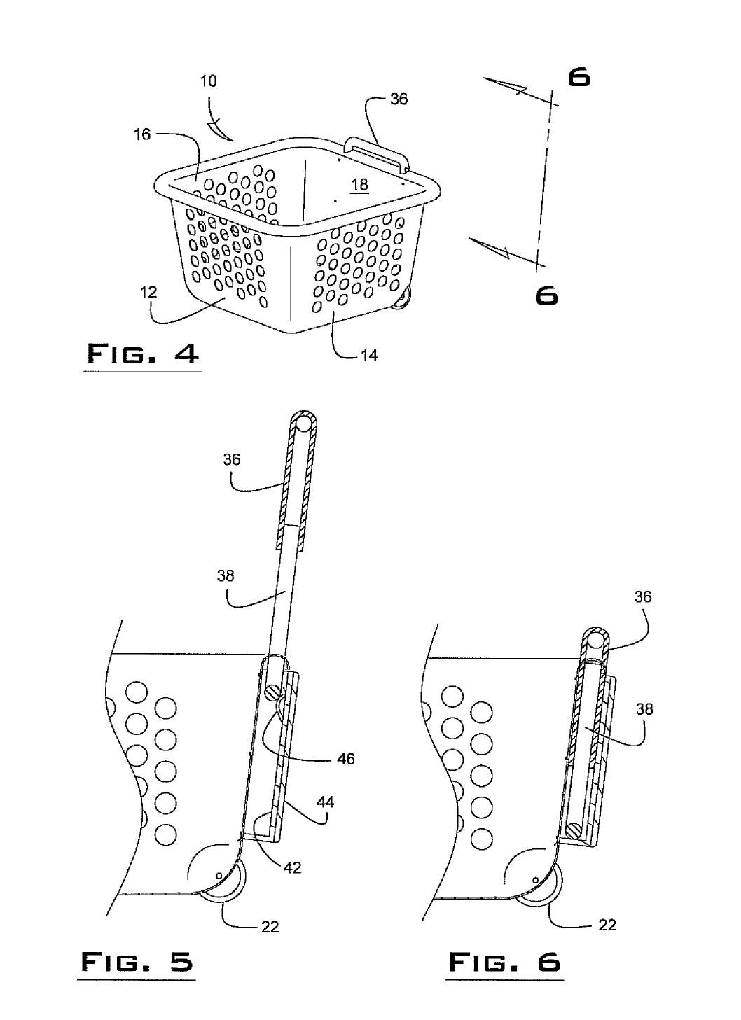

As shown in combination with FIG. 2, which is a rotated and rear facing perspective view, as well as in the exploded view of FIG. 3, the basket design includes a generally rectangular or square shaped body exhibiting four interconnecting sides 12-18 collectively defining an upper rim as well as a closed bottom 20. While not limited to any specific material, the body can be constructed of a plastic or like material exhibiting the necessary properties of durability. As further shown, the sides 12-18 can include apertures or the like, and the bottom 20 and side edge 14 and 16 interfaces (as best shown in FIG. 2) can be configured to support in minimally projecting fashion a pair of wheels 22 and 24.

As further shown in FIG. 3, a rod 26 is provided for inserting through central apertures in the wheels 22 and 24 as well as additional apertures defined through a bottom edge corresponding to aligned recessed and opposite edge located pockets, see at 28 and 30 in FIG. 3. A pair of bolts 32 and 34 are provided and secure to ends of the rod 26 projecting beyond the wheels 22 and 24 and, in this fashion, provide wheeled support to the assembly.

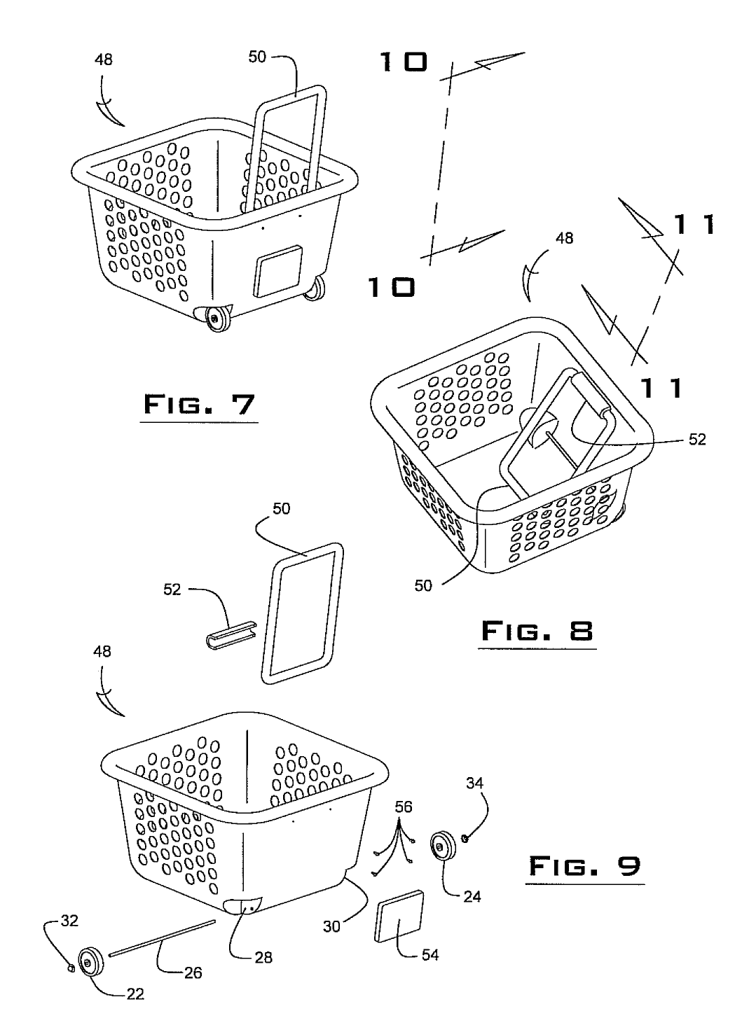

A telescoping handle assembly includes, as best shown in FIG. 3, a pair of opposing and generally “U” shaped components including an upper and outer telescoping member 36 and a lower and inner telescoping member 38, the degree of relative positioning there between being determined by a push button mechanism 40. The lower “U” shaped member 38 is secured upon a surface of the back side 18 via a first and interiorly channeled bracket 42 which seats the member 38 in limited vertical displacing fashion (see as further shown in reference to FIGS. 5-6) to the rear basket surface 18 (such as via a plurality of screws which attach to apertures in the side 18 (see FIG. 3). A cover plate 44 attaches over the substrate bracket 42 and, in use, provides the additional feature a rear projecting surface for assisting in traversing edge riser surfaces associated with a flight of stairs.

As shown in FIG. 4, the handle subassembly is illustrated in a fully retracted position, whereas, in the side rear cutaway of FIG. 5 is illustrated in a fully extended position by which the upper/outer telescoping member 36 is fully elevated along with the lower/inner telescoping member 38 being upwardly elevated to a point in which its lower interconnected edge clears a pair of inner projecting channel abutments (see at 46 in each of FIGS. 3 and 5) in order to secure to the upper extended position. FIG. 6 is a succeeding cutaway illustration of the handle in a fully retracted position corresponding to the illustration of FIG. 4 and by which the lower/inner member 36 is fully recessed and the upper/outer telescoping member 38 is substantially seated within the bracket channel, with only its upper connecting edge projecting slightly beyond (see again also FIG. 4). For purposes of each handle construction described, it is understood that the material construction, as with the basket, can include any of a durable plastic, a lightweight aluminum or other suitable material.

Referring now to FIGS. 7-11, a series of perspective, exploded and cutaway views are shown of an assembly 48 according to a further desired embodiment. For purposes of ease of description, identical features to those disclosed in the initial embodiment of FIGS. 1-6 are not repeated, and which again include the construction of the four sided, open top and closed body with lower side edge supported wheels.

In substitution of the linearly telescoping handle with inner and outer telescoping portions, the variant of FIG. 7 teaches a single four-sided and generally rectangular tubular handle 50 in which a first interconnecting end is pivotally supported, via a half-tunnel or half-collar portion 52 secured along an upper inside and proximate edge surface of the basket. In this fashion, the handle 50 is capable of being rotated between an outer rotated and use position (FIG. 7) and an inner rotated and seating/storage position (FIG. 8) in which it is recessed within the volume defining interior of the basket.

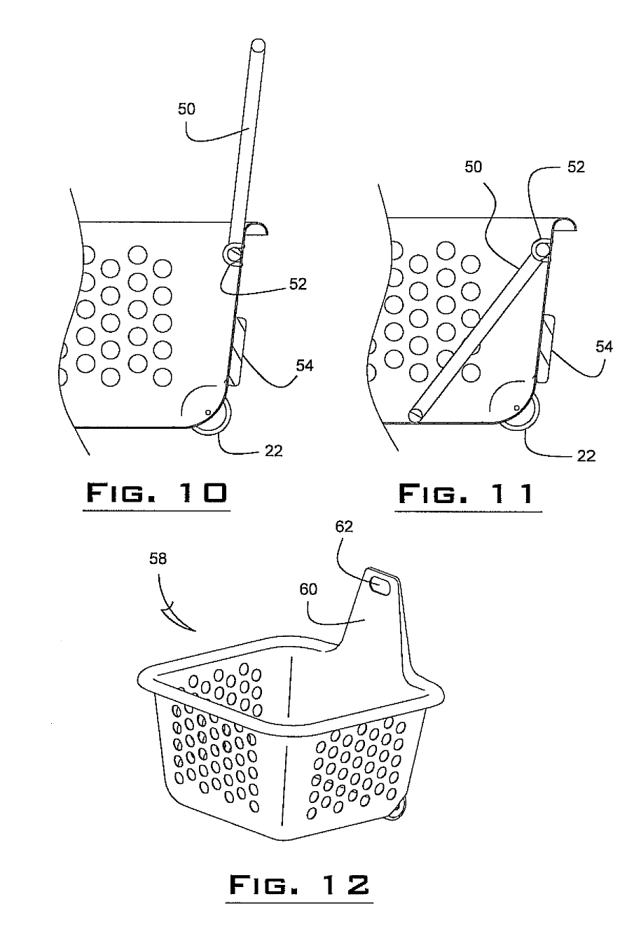

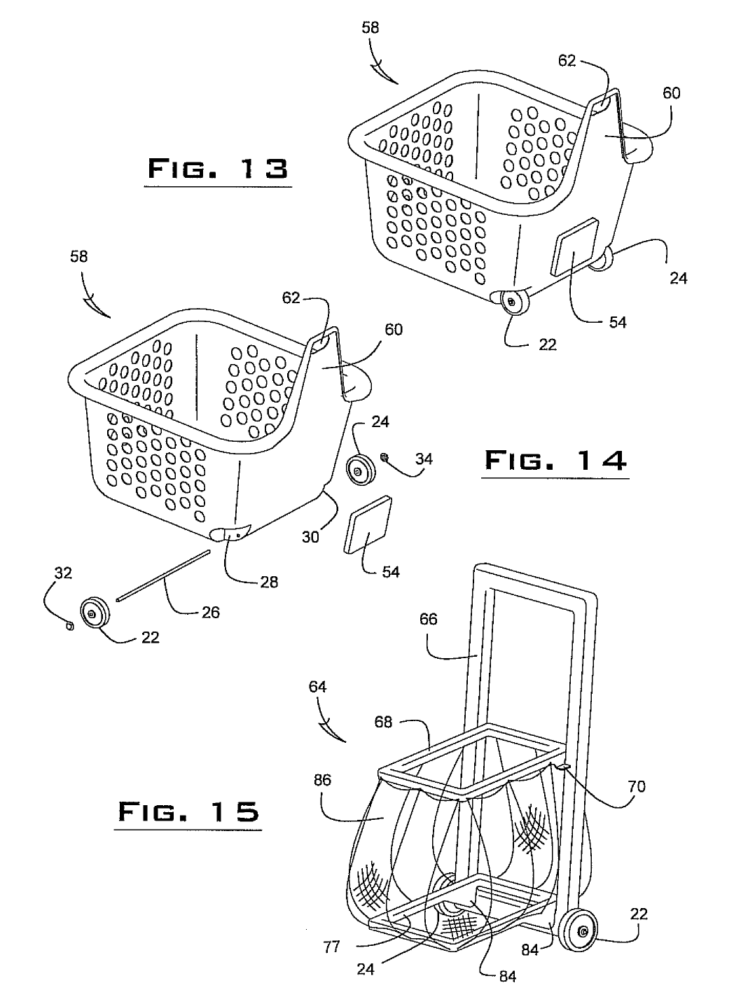

Although not further shown, locking structure can be incorporated between the rotating tubular handle 50 and the supporting collar 52, this intended to maintain the handle in such as a fixed extending orientation (see also side cutaway views of FIGS. 10 and 11). Other features include a rear surface mounted pad support 54, such as which is mounted by a plurality of fasteners 56 (FIG. 9) to an intermediate rear facing surface of the basket and thereby providing the desired feature of riser assist support during traversing up/down a flight of stairs. It is further again understood that the pad support 54 can exhibit any size, thickness and material consistency, including without limitation rigid foam, sponge or other padding construction such as to facilitate up/down traverse along vertical stair risers (not shown).

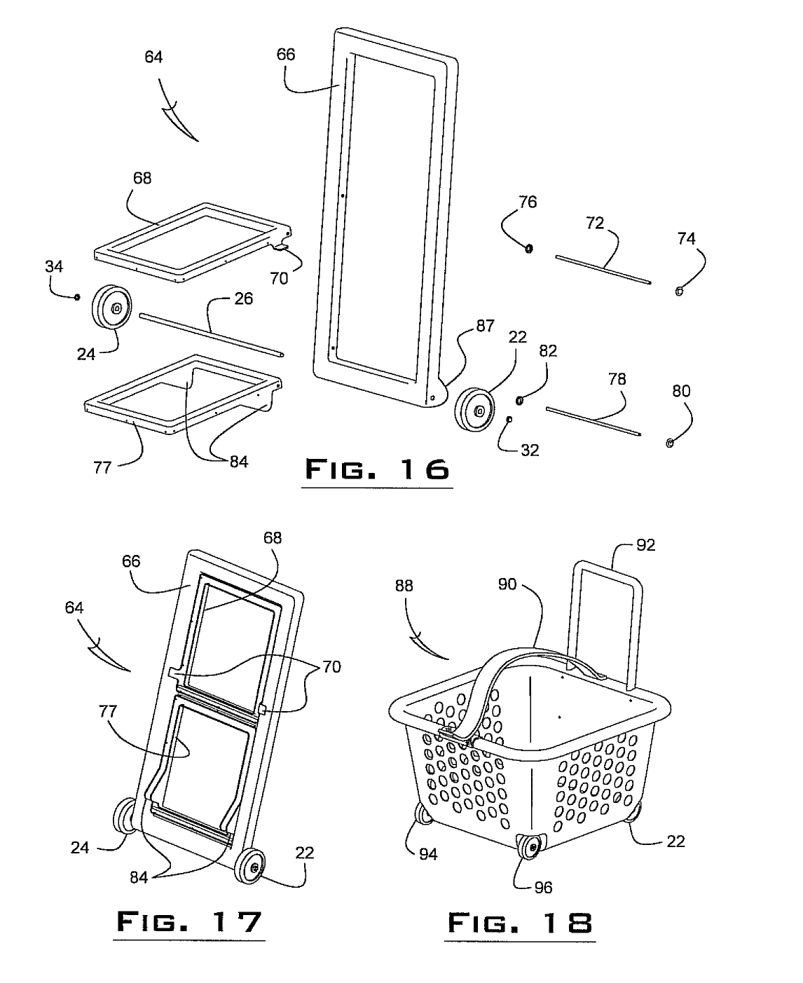

FIGS. 12-14 illustrate a series of perspective and exploded views of a wheeled basket assembly 58 exhibiting an integrally formed and rigid/fixed handle 60 forming a portion of the body construction and in combination with the remaining features of the variant in FIG. 7. The handle 60 includes an upper configured gripping aperture 62 and, in use, permits the body to be rotated and traversed along a surface. The configuration of the integrally formed handle 60 is further such that the basket design can be conveniently stacked in multiple fashion.

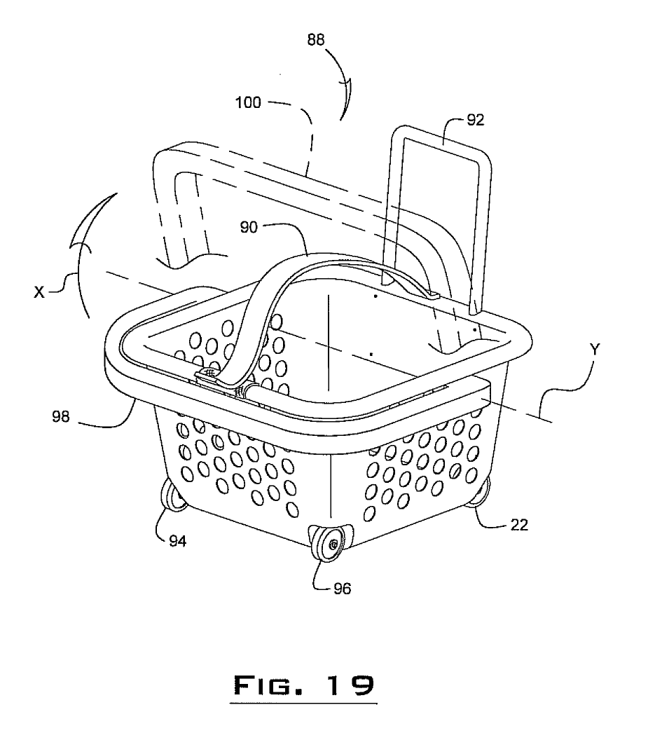

Referring now to FIGS. 15-17, a series of assembly, exploded and folded/stored illustrations are shown of a basket design according to a still further embodiment 64 and which illustrates an outer and generally frame defining and four sided wheeled support (also termed a main frame exhibiting a generally window pane like configuration as shown at 66 in FIG. 16. An upper pivotal support 68 exhibits a generally four sided frame construction (similar in shape to that associated with main frame 66). The upper support 68 includes a rear edge bracket extension (see at 70) such that, upon being mounted to an intermediate inner surface supporting location associated with the main frame 66 via inserting support rod 72 and end attached fasteners 74 and 76, permits the upper support 68 to be rotated between a first flush position (FIG. 17) in which the pivotal support 68 is substantially seated within the interior of the main frame 66 and a downward rotated position (FIG. 15) in which the edge extending bracket projections 70 abut against surfaces of the main frame 66.

A lower support 77 is pivotally secured to a lower location of the main frame 66, see again FIG. 16 which shows inserting rod 78 with end attached fasteners 80 and 82 for mounting the lower pivotal frame 77 at a location just above the wheeled supporting location of the wheels 22 and 24 and associated wheel support rod 26, this further mounting through a third interior passage defining location extending widthwise in the main frame 66. A pair of generally triangular shaped abutment supports 84 and provided and extend linearly and downwardly from lower most proximate side locations of the lower pivotal frame 77, these including a bottom facing and seating surface. Upon rotating the lower frame 77 from the flush retracted position of FIG. 17, to the lowered position of FIG. 15, inwardly facing and angled edge surfaces of the abutment supports 84 abut the lower cross extending portion of the main pane 66.

As further shown in FIG. 15, a mesh or like volume defining fabric material 86 is provided in generally bag form (this generally substituting for the rigid volume enclosing construction of the earlier disclosed basket variants) and includes an open upper end which is mounted in a desired fashion to the upper pivotal support frame 68, with the bottom of the bag 86 supported upon the lower pivotal frame 77. As with the previous variants, a suitable pad or rear edge projecting support can be incorporated into a bottom location of the main frame 66, such as depicted at 87 in FIG. 16, and in order to provide riser support during traversing up and down stairs.

Referring to FIG. 18, an illustration is provided at 88 of a yet further variant of basket design and illustrating an overhead extending support strap 90 (either rigid, semi-rigid or flexible) in combination with a rear secured and extensible handle 92. Although not shown, the present invention contemplates one or more straps such as which can hold the laundry items (not shown) in place.

Additionally shown is the single rear pair of wheels (shown by selected rear wheel 22) augmented by a second pair of forward edge wheels (further shown at 94 and 96) and which are supported such as by an additional common drive support rod or axle (reference again being made to shaft 22 in FIG. 3). Otherwise, the basket design is substantially similar to that previously described in FIG. 1 such that a repetitive description is unnecessary.

Finally, and referring to FIG. 19, illustrated is a redesigned variant of wheelable basket similar to that shown in FIG. 18 and further illustrating the feature of an additional pivotal handle (see in solid at 98 in stored position and further in phantom 100 in upward rotated use position about pivot axis Y). The handle 98 is secured proximate opposite and upper edge locations of the basket 88 and, as is further shown, is rotatable over the support strap 90 also depicted in FIG. 18.

Having described my invention, other and additional preferred embodiments will become apparent to those skilled in the art to which it pertains, and without deviating from the scope of the appended claims.

I claim:

1. A wheeled basket, comprising:
an interior volume defining body including a base and a plurality of upwardly extending sides;
a wheeled support incorporated into a bottom proximate extending edge of said body;
a handle extending from a rear of said body; and
a support extending from a rear outer surface of said body and establishing a sliding surface for vertically traversing said along edge surfaces associated with each succeeding stair riser interface.

2. The invention as described in claim 1, said wheeled support further comprising a rod inserting through central apertures in first and second wheels as well as additional apertures defined through a bottom edge aligning with opposite edge recessed pockets in said body, a pair of bolts securing to projecting ends of said beyond said wheels.

3. The invention as described in claim 1, further comprising an extensible handle secured to a rear portion of said body.

4. The invention as described in claim 3, said handle further comprising a pair of opposing and generally “U” shaped components including an upper and outer telescoping member and a lower and inner telescoping member.

5. The invention as described in claim 4, further comprising a push button mechanism incorporated into said upper telescoping member and establishing a degree of relative positioning between said upper and lower telescoping members.

6. The invention as described in claim 4, further comprising said lower “U” shaped member is secured upon said rear surface of said body via a first and interiorly channeled bracket which seats said lower member in limited vertical displacing fashion, a cover plate attaching over said bracket and, in use, establishing said rear extending support surface.

7. The invention as described in claim 1, further comprising a pivotal handle secured to an inside rear portion of said body.

8. The invention as described in claim 7, further comprising a four-sided and generally rectangular tubular handle in which a first interconnecting end is pivotally supported, via a half-collar portion secured along an upper inside and proximate edge surface of said body and so that said handle is capable of being rotated between an outer rotated and use position and an inner rotated and seating/storage position in which it is recessed within the volume defining interior of said body.

9. The invention as described in claim 1, said support further comprising a rear extending pad support secured to said body.

10. The invention as described in claim 1, further comprising an integrally formed and rigid handle extending from an upper edge of said body, said handle including an upper configured gripping aperture.

11. The invention as described in claim 10, said body and integrally formed handle exhibiting a specified shape such that a plurality of identical bodies can be stacked in multiple fashion.

12. The invention as described in claim 1, further comprising a strap secured over an open top of said body and securing to opposite edges.

13. The invention as described in claim 1, said body further comprising a main frame, an upper pivotal support secured to a first location of said frame, and a second lower pivotal support secured to a second location of said frame.

14. The invention as described in claim 13, further comprising a bag enclosure suspended from said upper support and supported upon said lower support.

15. The invention as described in claim 13, said upper pivotal support further comprising a four sided frame construction secured to an upper location of said main frame, a rear edge bracket extension extending from a location of said upper support such that, upon being mounted to an intermediate inner surface supporting location associated with said main frame via an inserting support rod and end attached fasteners, said upper support is rotated between a first flush position in which it is substantially seated within an open interior of said main frame and a downward rotated position in which said edge extending bracket projection abuts against a surface of said main frame.

16. The invention as described in claim 13, said lower support further comprising a four sided frame construction pivotally secured to a lower location of said main frame via an inserting rod with end attached fasteners for mounting said lower pivotal frame at a location just above wheeled supporting locations.

17. The invention as described in claim 16, further comprising at least one projecting abutment supports extend from a proximate side location of said lower pivotal frame such that, upon rotating said lower frame from a flush retracted position to a lowered position, an inwardly facing and angled edge surface of said abutment support abuts a lower cross extending portion of said main frame.

18. The invention as described in claim 17, further comprising a pair of triangular shape abutment supports extending in a generally linearly and underside projecting fashion from first and second side locations of said lower pivotal frame.

19. A wheeled support, comprising:
a main frame, an upper pivotal support secured to a first location of said frame, and a second lower pivotal support secured to a second location of said frame.
a wheeled support incorporated into a bottom proximate extending edge of said body, said wheeled support further comprising a rod inserting through central apertures in first and second wheels as well as additional apertures defined through a bottom edge aligning with opposite edge recessed pockets in said body, a pair of bolts securing to projecting ends of said beyond said wheels; and
a bag enclosure suspended from said upper support and supported upon said lower support.

20. A wheeled basket, comprising:
an interior volume defining body including a base and a plurality of upwardly extending sides;
a wheeled support incorporated into a bottom proximate extending edge of said body;
an extensible handle extending from a rear of said body, said handle further comprising a pair of opposing and generally “U” shaped components including an upper and outer telescoping member and a lower and inner telescoping member; and
a support extending from a rear outer surface of said body and establishing a sliding surface for vertically traversing said along edge surfaces associated with each succeeding stair riser interface.
